(19) United States
(12) Patent Application Publication
(10) Pub. No.: US 2025/0052231 A1
(43) Pub. Date: Feb. 13, 2025

(54) METHOD FOR OPERATING A POWER-TO-GAS CONVERTER WITH A WIND TURBINE, POWER-TO-GAS CONVERTER AND WIND TURBINE

(71) Applicant: Siemens Gamesa Renewable Energy A/S, Brande (DK)

(72) Inventor: Gustav Hoegh, Vejle (DK)

(21) Appl. No.: 18/718,524

(22) PCT Filed: Nov. 21, 2022
(86) PCT No.: PCT/EP2022/082577

§ 371 Date: Jun. 11, 2024

(30) Foreign Application Priority Data
Dec. 15, 2021 (EP) 21214674.0

(51) Int. Cl. F03D 9/19

(52) U.S. Cl. CPC F03D 9/19; F05B 2220/61

(57) ABSTRACT

A method for operating a power-to-gas converter with a wind turbine is provided, the power-to-gas converter being electrically connected to the wind turbine, wherein the power-to-gas converter generates at least one gas-mixture, wherein a measuring unit of the power-to-gas converter measures a concentration of at least one gas in the gas-mixture, wherein a control unit of the power-to-gas converter controls the generation of the at least one gas-mixture by the power-to-gas converter, wherein a first threshold value of the concentration of the at least one gas in the gas-mixture is set within the control unit, wherein the generation of the at least one gas-mixture is stopped by the control unit when the measured concentration of the at least one gas in the gas-mixture reaches or exceeds the first threshold value. Furthermore, a power-to-gas converter and a wind turbine is also provided.

### CROSS-REFERENCE TO RELATED APPLICATIONS

This application is a national stage application of PCT Application No. PCT/EP2022/082577, having a filing date of Nov. 21, 2022, which claims priority to EP Application Serial No. 21214674.0, having a filing date of Dec. 15, 2021, the entire contents both of which are hereby incorporated by reference.

### FIELD OF TECHNOLOGY

The following relates to a method for operating a power-to-gas converter with a wind turbine, a power-to-gas converter and a wind turbine.

### BACKGROUND

The conversion of power to gas might produce unwanted byproducts and/or disadvantages circumstances. In an embodiment, the electrolysis of water produces Hydrogen and Oxygen and a certain amount of gasses crossover e.g., hydrogen crossover into oxygen. At a level above approximately 4%, the gas-mixture becomes explosive, which is to be avoided.

The gas-mixture produced by a power-to-gas converter depends on the current density of the provided energy to the power-to-gas converter. The known data imposes a lower limit for a power-to-gas converter current at which the power-to-gas converter can safely be operated. As a consequence, this limits the lowest amount of power the power-to-gas converter can absorb in order to be operated safely.

In combination with a wind turbine configuration without grid, this means that when the turbine is producing low power due to low wind speed, the power-to-gas converter current may become too low, and the wind turbine and/or the power-to-gas converter must be stopped. If a fixed minimum current limit is used, this means that the turbine production is stopped below a certain power level in order to operate the power-to-gas converter in a safe state. This minimum limit might be chosen conservatively to ensure that an acceptable mixture ratio of the produced gas-mixture is never exceeded, no matter the current operational environment, the age of the cells, tolerances for the components, temperature- and/or pressure-conditions. This results in lost production of gas at low wind speeds.

### SUMMARY

An aspect relates to a method for operating a power-to-gas converter with a wind turbine, a power-to-gas converter and a wind turbine, that overcome at least some of the aforementioned disadvantages in a convenient and cost-efficient way.

Thereby, the features and details described in connection with embodiments of the method for operating a power-to-gas converter with a wind turbine, the power-to-gas converter and the wind turbine of embodiments of the invention may be applied in connection with each other so that regarding the disclosure of the individual aspects of embodiments of the invention it is or can be referred to one another.

According to a first aspect of embodiments of the invention, the above-mentioned aspect is solved by a method for operating a power-to-gas converter with a wind turbine. The power-to-gas converter is electrically connected to the wind turbine, wherein the power-to-gas converter generates at least one gas-mixture, wherein a measuring unit of the power-to-gas converter measures a concentration of at least one gas in the gas-mixture. In embodiments, the method of the invention is characterized in that a control unit of the power-to-gas converter controls the generation of the at least one gas-mixture by the power-to-gas converter, wherein a first threshold value of the concentration of the at least one gas in the gas-mixture is set within the control unit, wherein the generation of the at least one gas-mixture is stopped by the control unit when the measured concentration of the at least one gas in the gas-mixture reaches or exceeds the first threshold value.

In other words, embodiments of the invention discloses using a feedback signal from the measured gas-mixture ratio to determine when to stop the production of the at least on gas-mixture by the power-to-gas converter. In an embodiment, this concludes to instead of imposing a lower current limit, production is allowed to continue until a certain limit or threshold value is reached or exceeded. This allows operation of the power-to-gas converter to a better efficiency, and production losses can thereby be minimized. If the wind turbine and/or the power-to-gas converter is connected to a power grid, it is a viable option to import power from the power grid. In an embodiment, this can be used to supplement the power produced from the wind turbine, such that the combined power from the power grid and the wind turbine results in a current for the power-to-gas converter that is able to produce an acceptable and safe to operate gas-mixture.

In an embodiment, the power-to-gas converter is designed as an electrolyzer to generate hydrogen from water and/or the wind turbine is designed as an off-grid wind turbine, whereas an off-grid wind turbine is characterized by not being connected to a main power grid, in which power is supplied by other sources, especially by other non-wind turbine sources. The control unit can be designed to be integrated with the power-to-gas converter or to be installed separately. The gas-mixture consists of at least one gas, for example a variety of gasses. The measuring unit is designed to measure at least the concentration of one of the gases of the gas-mixture, and thereby the measuring unit and/or the control unit is able to determine whether the gas-mixture is in a safe to operate condition. Furthermore, the control unit is connected to the measuring unit to transmit data by wire or wirelessly. The control unit is designed to set at least one first threshold value for a measured concentration of the at least one gas in the gas-mixture. If a measured concentration of the at least one gas in the gas-mixture reaches or exceeds its threshold value, the control unit stops the generation of the at least one gas-mixture by the power-to-gas converter. The stopping of the generation of the at least one gas-mixture can be achieved by various means which are described in detail in future paragraphs.

In embodiments, the method of the invention is especially desired because it enables the generation of the at least one gas-mixture by the power-to-gas converter in a safely manner by measuring the concentration of at least one gas in the gas-mixture, wherein a first threshold value of the concentration of the at least one gas in the gas-mixture is set within the control unit, wherein the generation of the at least one gas-mixture is stopped by the control unit when the measured concentration of the at least one gas in the gas-mixture reaches or exceeds the first threshold value.

The power-to-gas converter may be provided with power by the wind turbine, wherein the control unit is designed to monitor the provided power, wherein a second threshold value of the provided power is set within the control unit, wherein the generation of the at least one gas-mixture is stopped when a determined second threshold value is reached or undercut. Additional to the first threshold value for the concentration of at least one gas of the gas-mixture, the setting of a second threshold value for the provided power to the power-to-gas converter is a desired design of embodiments of the method of the invention. As described before, a lower limit of the provided power as the second threshold value is desired to avoid unsafe conditions of the at least one gas-mixture and/or the power-to-gas converter. Thereby the two threshold values can enable a dual protection for embodiments of the method of the invention and the power-to-gas converter.

The measuring unit of the power-to-gas converter may determine the concentration of at least one gas in the gas-mixture within an outgoing gas path of the power-to-gas converter. Furthermore, the outgoing gas path can be designed as an exhaust gas path of the power-to-gas converter. The outgoing gas path can be designed as an exhaust gas path of a cathode side of the power-to-gas converter, of an anode side of the power-to-gas converter and/or of a common exhaust gas path of the power-to-gas converter. The measuring of the concentration of at least one gas in the gas-mixture within an outgoing gas path is a desired design since an unsafe condition within the at least one gas-mixture can be directly measured, and as a consequence, the generation of the at least one gas-mixture by the power-to-gas converter can be stopped.

The generation of the at least one gas-mixture may be stopped by the control unit by disconnecting a powerline of the power-to-gas converter for providing power to the power-to-gas converter and/or by closing off a fluid infeed path of the power-to-gas converter for providing fluid to the power-to-gas converter. As described before, the stopping of the generation of the at least one gas-mixture can be achieved by various means. In an embodiment, the stopping of the generation of the at least one gas-mixture is achieved by the control unit by disconnecting a power-line to the power-to-gas converter and/or by closing off a fluid infeed path of the power-to-gas converter. In the example of the power-to-gas converter being an electrolyzer to generate hydrogen from water, the generation can be stopped by disconnecting the power to the electrolyzer and/or by shutting off the infeed line of water to the electrolyzer. This can be achieved by commonly known means as valves, switches and circuits within the control unit.

In embodiments, the fluid infeed path refers to that flow of fluid which is intended to be used for generating the gas-mixture. To give a concrete example, wherein the power-to-gas converter is an electrolyzer and the fluid is water: In this case, the water infeed flow to the electrolyzer could be closed off when the first threshold value is reached or exceeded. This does not exclude, however, that water for other purposes, such as cooling the electrolyzer or related components, still flows to and through the electrolyzer.

In embodiments, the method may further comprise a storing of power in a power storage unit of the power-to-gas converter, wherein the power storage unit is electrically connected to the wind turbine and the power-to-gas converter, especially in between the wind turbine and the power-to-gas converter. A power storage is a desired addition to the power-to-gas converter and embodiments of the method of the invention since a power storage enables a more efficient use of the power-to-gas converter. The power storage may be used as a backup power storage for safely stopping and/or ramping up the generation of the at least one gas-mixture by the power-to-gas converter. Furthermore, the power storage allows to overcome drops of provided power, especially below a second threshold value, for a certain amount of time, wherein the duration is specified by the amount of power stored or storable in the power storage. In other words, a power storage enables a sufficient amount of power to be stored in the power storage to safely stop and/or ramp up the generation of the at least one gas-mixture by the power-to-gas converter as well as the amount of power fed to the power-to-gas converter being kept constant to insure a safe operation mode for the power-to-gas converter.

A power state of the power storage unit may be measured by a measuring unit of the power storage unit of the power-to-gas converter, wherein the control unit controls the generation of the at least one gas-mixture by the power-to-gas converter in accordance with the measured power state. It is an additional desired feature of embodiments of the method of the invention to measure a power state of the power storage in order to control the generation of the at least one gas-mixture by the power-to-gas converter in accordance with the measured power state. As described before, a power storage in combination with a measured power state enables a sufficient amount of power to be stored in the power storage to safely stop and/or ramp up the generation of the at least one gas-mixture by the power-to-gas converter as well as the amount of power fed to the power-to-gas converter to be kept constant to insure a safe operation mode for the power-to-gas converter.

In embodiments, the method may further comprise a storing of the at least one generated gas-mixture in a gas storage unit, wherein the gas storage unit is connected to the power-to-gas converter to receive the at least one generated gas-mixture. A gas storage unit is a desired addition to embodiments of the method and the power-to-gas converter of the invention, because the gas storage enables the storing of the at least one generated gas-mixture. Furthermore, the gas storage allows for a desired measuring of the concentration of at least one gas in the gas-mixture. The gas storage further allows for a higher volume of gas-mixture to be stored and especially therefore for a less sensitive change in the concentration of at least one gas in the gas-mixture. In an embodiment, when the concentration of at least one gas in the generated gas-mixture slowly starts to rise, the gas storage, its volume to store the gas and/or already existing gas-mixture in the gas storage act as a buffer, which decreases the overall concentration of at least one gas in the gas-mixture in the tank in comparison to the concentration of the one gas in the currently generated gas-mixture. Thereby, in embodiments the method of the invention is less sensitive, and the generation of the at least one gas-mixture is more stable.

A gas level of the gas storage unit may be measured by a measuring unit of the gas storage unit, wherein the control unit controls the generation of the at least one gas-mixture by the power-to-gas converter in accordance with the measured gas level. It is an additional desired feature of embodiments of the method of the invention to measure a gas level of the gas storage in order to control the generation of the at least one gas-mixture by the power-to-gas converter in accordance with the measured gas level. The gas storage in combination with a measured gas level enables an efficient generation of the at least one gas-mixture by the power-to-gas converter as well as a buffer for the concentration of the at least one gas in the gas-mixture in order to insure a safe operation mode for the power-to-gas converter.

According to a second aspect of embodiments of the invention, the initially stated aspect is solved by a power-to-gas converter comprising a measuring unit and a control unit. The power-to-gas converter is designed to implement a method according to the first aspect of embodiments of the invention. With the power-to-gas converter described, all the advantages already outlined with respect to embodiments of the method of the invention according to the first aspect of embodiments of the invention are obtained. An electrolyzer may be used as the power-to-gas converter to generate hydrogen from water.

According to a third aspect of embodiments of the invention, the initially stated aspect is solved by a wind turbine comprising a power-to-gas converter, wherein the wind turbine is electrically connected to the power-to-gas converter. The power-to-gas converter is designed according to the second aspect of embodiments of the invention. With the wind turbine described, all the advantages already outlined with respect to the power-to-gas converter according to the second aspect of embodiments of the invention and embodiments of the method of the invention according to the first aspect of embodiments of the invention are obtained. In an embodiment, the wind turbine is providing the power-to-gas converter with power. The wind turbine may be designed as an off-grid wind turbine. An off-grid wind turbine is characterized by not being connected to a main power grid, in which power is supplied by other sources, especially by other non-wind turbine sources.

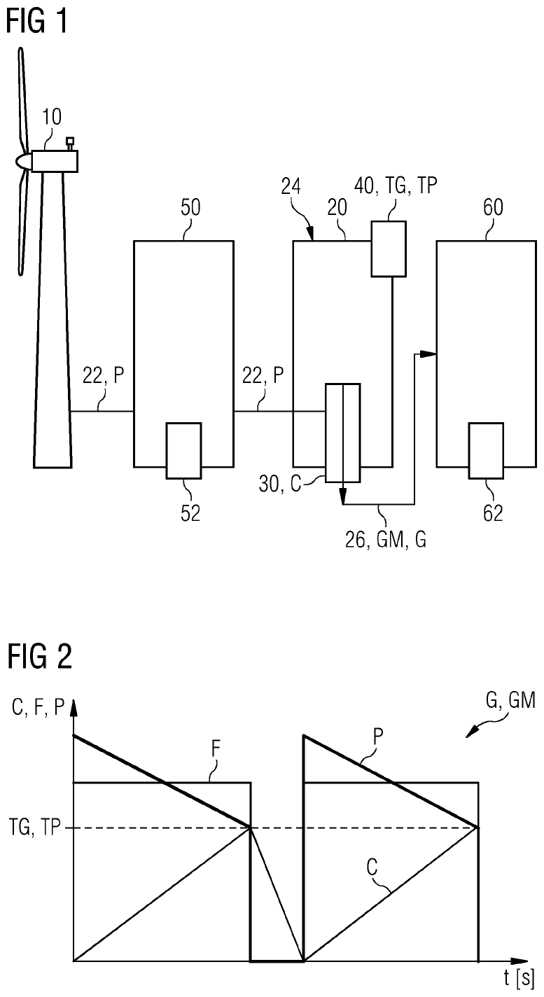

Further advantages, features and details of embodiments of the invention unfold from the following description, in which by reference to drawings FIGS. 1 and 2, embodiments of the present invention are described in detail. Thereby, the features from the claims as well as the features mentioned in the description can be essential for embodiments of the invention as taken alone or in an arbitrary combination.

### BRIEF DESCRIPTION

Some of the embodiments will be described in detail, with references to the following Figures, wherein like designations denote like members, wherein:

FIG. 1 a schematic illustration of a first embodiment of a wind turbine and a power-to-gas converter with a power storage unit and a gas storage unit according to embodiments of the invention; and

FIG. 2 a schematic graph of the concentration of a gas of the gas-mixture, fluid and power provided to the power-to-gas converter over time.

### DETAILED DESCRIPTION

FIG. 1 shows a schematic illustration of a first embodiment of a wind turbine 10 and a power-to-gas converter 20 with a power storage unit 50 and a gas storage unit 60 according to embodiments of the invention. The power-to-gas converter 20 is electrically connected via the power storage 50 to the wind turbine 10, wherein the power-to-gas converter 20 generates one gas-mixture GM, wherein a measuring unit 30 of the power-to-gas converter 20 measures a concentration C of one gas G in the gas-mixture GM and wherein a control unit 40 of the power-to-gas converter 20 controls the generation of the one gas-mixture GM by the power-to-gas converter 20. A first threshold value TG of the concentration C of the at least one gas G in the gas-mixture GM is set within the control unit 40, wherein the generation of the at least one gas-mixture GM is stopped by the control unit 40 when the measured concentration C of the at least one gas G in the gas-mixture GM reaches or exceeds the first threshold value TG. The power-to-gas converter 20 is provided with power P by the wind turbine 10, wherein the control unit 40 is designed to monitor the provided power P, wherein a second threshold value TP of the provided power P is set within the control unit 40, wherein the generation of the at least one gas-mixture GM is stopped when a determined second threshold value TP is reached or undercut. The measuring unit 30 of the power-to-gas converter 20 determines the concentration C of at least one gas in the gas-mixture GM within an outgoing gas path 26 of the power-to-gas converter 20. A storing of power P is enabled by a power storage unit 50 of the power-to-gas converter 20, wherein the power storage unit 50 is electrically connected in between the wind turbine 10 and the power-to-gas converter 20. A power state of the power storage unit 50 is measured by a measuring unit 52 of the power storage unit 50, wherein the control unit 40 controls the generation of the at least one gas-mixture GM by the power-to-gas converter 20 in accordance with the measured power state. A storing of the generated gas-mixture GM is enabled by a gas storage unit 60 of the power-to-gas converter 20, wherein the gas storage unit 60 is connected to the power-to-gas converter 20 to receive the generated gas-mixture GM. A gas level of the gas storage unit 60 is measured by a measuring unit 62 of the gas storage unit 60, wherein the control unit 40 controls the generation of the at least one gas-mixture GM by the power-to-gas converter 20 in accordance with the measured gas level.

FIG. 2 shows a schematic graph of the concentration C of a gas G of the gas-mixture GM, fluid F and power P provided to the power-to-gas converter 20 (not shown) over time. The generation of the at least one gas-mixture GM is stopped by the control unit 40 (not shown) when a determined second threshold value TP is reached or undercut and/or when the measured concentration C of the at least one gas G in the gas-mixture GM reaches or exceeds the first threshold value TG. The generation of the at least one gas-mixture GM is stopped by the control unit 40 (not shown) by disconnecting a powerline 22 (not shown) of the power-to-gas converter 20 (not shown) for providing power P to the power-to-gas converter 20 (not shown) and/or by closing off a fluid infeed path 24 (not shown) of the power-to-gas converter 20 (not shown) for providing fluid F to the power-to-gas converter 20 (not shown).

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for operating a power-to-gas converter with a wind turbine, the power-to-gas converter being electrically connected to the wind turbine,
generating at least one gas-mixture by the power-to-gas converter,
measuring a concentration of at least one gas in the at least one gas-mixture with a measuring unit of the power-to-gas converter,
wherein,
controlling the generation of the at least one gas-mixture by the power-to-gas converter using a control unit of the power-to-gas converter,
setting a first threshold value of the concentration of the at least one gas in the at least one gas-mixture within the control unit,
stopping the generation of the at least one gas-mixture by the control unit when the measured concentration of the at least one gas in the at least one gas-mixture reaches or exceeds the first threshold value, and
stopping the generation of the at least one gas-mixture by the control unit by disconnecting a powerline of the power-to-gas converter for providing power to the power-to-gas converter and by closing off a fluid infeed path of the power-to-gas converter for providing fluid to the power-to-gas converter.

2. The method according to claim 1,
wherein,
the power-to-gas converter is provided with power by the wind turbine, wherein the control unit is configured to monitor the provided power, wherein a second threshold value of the provided power is set within the control unit, wherein the generation of the at least one gas-mixture is stopped when a determined second threshold value is reached or undercut.

3. The method according to claim 1,
wherein,
the measuring unit of the power-to-gas converter determines the concentration of at least one gas in the at least one gas-mixture within an outgoing gas path of the power-to-gas converter.

4. The method according to claim 1,
wherein,
the method further comprises a storing of power in a power storage unit of the power-to-gas converter, wherein the power storage unit is electrically connected to the wind turbine and the power-to-gas converter, especially in between the wind turbine and the power-to-gas converter.

5. The method according to claim 4,
wherein,
a power state of the power storage unit is measured by a measuring unit of the power storage unit, wherein the control unit controls the generation of the at least one gas-mixture by the power-to-gas converter in accordance with the measured power state.

6. The method according to claim 1,
wherein,
the method further comprises a storing of the at least one generated gas-mixture in a gas storage unit of the power-to-gas converter, wherein the gas storage unit is connected to the power-to-gas converter to receive the at least one generated gas-mixture.

7. The method according to claim 6,
wherein,
a gas level of the gas storage unit is measured by a measuring unit of the gas storage unit, wherein the control unit controls the generation of the at least one gas-mixture by the power-to-gas converter in accordance with the measured gas level.

8. A power-to-gas converter comprising a measuring unit and a control unit,
wherein,
the power-to-gas converter is configured to implement a method according to claim 1.

9. The power-to-gas converter according to claim 8,
wherein,
an electrolyzer is used as the power-to-gas converter to generate hydrogen from water.

10. A wind turbine comprising a power-to-gas converter, wherein the wind turbine is electrically connected to the power-to-gas converter,
wherein,
the power-to-gas converter is configured according to claim 8.

11. The wind turbine according to claim 10,
wherein,
the wind turbine is configured as an off-grid wind turbine.
